(19) United States
(12) Patent Application Publication
(10) Pub. No.: US 2006/0011532 A1
(43) Pub. Date: Jan. 19, 2006

(54) Chromatography cartridge

(76) Inventors: Peter C. Van Davelaar, Glen Allen, VA (US); Peter C. Rahn, Palmyra, VA (US)

Correspondence Address: FISH & RICHARDSON PC, P.O. BOX 1022, MINNEAPOLIS, MN, 55440-1022, US

(21) Appl. No.: 10/893,116

(22) Filed: Jul. 16, 2004

(51) Int. Cl. B01D 15/08

(52) U.S. Cl. 210/198.2; 73/61.52; 422/70

(57) ABSTRACT

A cartridge for use in purification processes, including liquid chromatography, scavenging and reactions, is described. In one embodiment, the cartridge can include a tubular member and at least one porous member fitted within the interior region of the tubular member. The tubular member can have an interior surface forming an interior region and an exterior surface. The exterior surface can include one or more ribs protruding from the exterior surface along at least a portion of the exterior surface, such as longitudinal ribs and/or whole or partial circumferential ribs.

### TECHNICAL FIELD

This invention relates to a cartridge used in purification processes including liquid chromatography.

### BACKGROUND

Liquid chromatography is a technique for separating the individual compounds that exist in a subject sample. In employing the technique, the subject sample is carried in a liquid, called a mobile phase. The mobile phase carrying the subject sample is caused to migrate through a media, called a stationary phase. Different components have differing rates of migration through the media, which effects the separation of the components in the subject sample. Liquid chromatography is commonly performed with reusable columns or with disposable cartridges, both of which are usually cylindrical, in which the media bed is bounded axially by porous members, or plates containing defined flow paths, through which the mobile phase flows.

FIGS. 1A and 1B illustrate a conventional compression module 10 and chromatography cartridge 12. The compression module 10 has a top head assembly 14 and a barrel assembly 16. The cartridge 12 is configured to fit within the barrel assembly 16, and the bed 19 is axially bounded by porous plates 18, 20. Optionally, a sample module (not shown) carrying a sample to be purified can be placed within the cartridge 12 above the porous plate 18. For example, a sample module as described in U.S. Pat. No. 6,139,733, issued Oct. 31, 2000 to Hargro et al., entitled “Module and Method for Introducing a Sample into a Chromatography Column”. The barrel assembly 16 includes a lower head 22 and a compressible seal 24, such as an O-ring. The top head assembly 14 includes at least one compressible seal 26, such as an O-ring, and may optionally include more than one, particularly if a sample module is used within the cartridge 12. The cartridge 12 is loaded with a stationary phase forming the bed 19, e.g., silica, which is bounded by the porous plates 18, 20, and placed into the barrel assembly 16. The porous plate 20 abuts the lower head 22. The barrel assembly 16 is attached to the top head assembly 14, and a top head 28 abuts the porous plate 18 in the cartridge 12, or the upper surface of a sample module if a sample module is used. A knob 30 can be rotated by a user to lower the internal components of the top head assembly 14, thereby asserting a downward force through the compression ring 34 and the top head 28 onto the upper porous plate 18, compressing the seals 26. The force is transferred through the cartridge to the lower head 22, and compresses the seal 24. The seals 26 and 24 prevent fluid from escaping either the top or bottom of the cartridge 12. Fluid can drain from the cartridge 12 via a passage 32, for example, to be collected in a collection vessel. Typically, the compression module 10 is reusable and the cartridge 12 is disposable.

Other conventional chromatography cartridges include using a glue dispenser tube filled with silica contained by a top and bottom plate. Outlet tubing is connected to the bottom of the tube. A cartridge module is used to position and hold a head inside the top of the glue tube to seal the tube and allow connection of inlet tubing. Syringe bodies are also used as chromatography columns and are filled with silica contained by a top and bottom plate. A syringe body without caps uses inlet and outlet connections similar to what are used with a glue tube cartridge. Syringe bodies with caps typically have a luer fitting molded into the cap as well as the bottom of the syringe body. Inlet and outlet tubes are connected to the luer fittings.

FIG. 2A shows an exemplary chromatography system 50 including a solvent reservoir 52, a pump 54, a chromatography column 58 and a sample collection vessel 60. A sample module 56 is shown inserted into the chromatography column 58. The chromatography column 58 may include a compression module housing a chromatography cartridge. A sample to be purified can be pre-absorbed onto media in the sample module 56 and inserted into the cartridge of the chromatography column 58. Solvent is then pumped from the solvent reservoir 52 through the sample module 56 and into the chromatography column 58 to perform a purification process. Alternatively, the sample can be injected or placed onto the top of the chromatography column 58 without using a sample module.

In yet another alternative, shown in FIG. 2B, another exemplary chromatography system 70 includes a solvent reservoir 72, a pump 74 and sample module 76 inserted into a remote holder 86. The remote holder 86 is connected to an inlet of a chromatography column 78. The chromatography column 78 can include a compression module and a cartridge. A sample collection vessel 84 is connected to an outlet 80 of the chromatography column 78. A sample to be purified is pre-absorbed onto media in the sample module 76, and then the module 76 is inserted into the remote holder 86. Solvent is pumped from the solvent reservoir 72 through the sample module 76, from where the solvent is directed into the chromatography column 78.

### SUMMARY

This invention relates to a cartridge used in purification processes including liquid chromatography. In general, in one aspect, the invention features an apparatus including a tubular member and at least one porous member fitted within the interior region of the tubular member. The tubular member has an interior surface forming an interior region and an exterior surface. The exterior surface includes one or more longitudinal ribs protruding from the exterior surface along at least a portion of the length of the exterior surface.

In general, in another aspect, the invention features an apparatus including a tubular member and at least one porous member fitted within the interior region of the tubular member. The tubular member can have an interior surface forming an interior region and an exterior surface. The porous member can include a frame having an annular outer member, and a porous inner member comprising a screen.

In general, in another aspect, the invention features an apparatus including a tubular member and at least one porous member fitted within the interior region of the tubular member. The tubular member includes an exterior surface, an interior surface forming an interior region, an inlet region, and an outlet region. The outlet region comprises an outlet plate that is positioned substantially perpendicular to a longitudinal axis of the tubular member and has an upper surface and a lower surface. The outlet plate includes an outlet opening extending through the outlet plate from the upper surface to the lower surface. An outlet member is attached to the lower surface of the outlet plate, the outlet member including an interior region forming an outlet passage. The outlet passage is axially aligned with the outlet opening formed in the outlet plate, and has a substantially cylindrical exterior region with a tapered end.

In general, in another aspect, the invention features an apparatus including a tubular member. The tubular member includes an exterior surface, an interior surface forming an interior region, an inlet region, and an outlet region. The outlet region includes an outlet plate that is positioned substantially perpendicular to a longitudinal axis of the tubular member and has an upper surface and a lower surface. The outlet plate includes an outlet opening extending through the outlet plate from the upper surface to the lower surface. An outlet member is attached to the lower surface of the outlet plate and includes an interior region forming an outlet passage, where the outlet passage is axially aligned with the outlet opening formed in the outlet plate. A guard member is attached to the lower surface of the outlet plate, the guard member having an interior region, where the outlet member is positioned within the interior region of the guard member.

In general, in another aspect, the invention features an apparatus including a tubular member. The tubular member has an interior surface forming an interior region and an exterior surface, where the exterior surface includes one or more ribs protruding from the exterior surface around all or a portion of the circumference of the exterior surface along at least a portion of the length of the exterior surface.

In general, in another aspect, the invention features an apparatus including a tubular member and at least one porous member fitted within an interior region of the tubular member. The tubular member has an interior surface forming an interior region and an exterior surface, where the interior surface of the tubular member has a substantially circular cross-section and includes at least one region of reduced interior diameter. The exterior circumferential surface of a porous member is positioned against the region of reduced interior diameter of the tubular member.

In general, in another aspect, the invention features an apparatus including a tubular member. The tubular member includes an exterior surface, an interior surface forming an interior region, an inlet region, and an outlet region. The outlet region includes an outlet plate that is positioned substantially perpendicular to a longitudinal axis of the tubular member and has an upper surface and a lower surface. The outlet plate includes an outlet opening extending through the outlet plate from the upper surface to the lower surface, and a plurality of ribs extending along at least a portion of the lower surface of the outlet plate. An outlet member is attached to the lower surface of the outlet plate and includes an interior region forming an outlet passage, where the outlet passage is axially aligned with the outlet opening formed in the outlet plate.

Implementations can include one or more of the following. At least one porous member can be orientated substantially perpendicular to a longitudinal axis of the tubular member and in contact with the interior surface of the tubular member. The exterior surface of the tubular member can include an upper portion having one or more projections protruding from the exterior surface. The one or more projections can be one or more ribs protruding from the exterior surface around all or a portion of the circumference of the exterior surface. The exterior surface of the tubular member can include a lower portion, wherein the one or more longitudinal ribs extend the length or a portion of the length of the lower portion.

The porous member can include a frame having an annular outer member, and a porous inner member. The porous member can further include one or more support members, where the porous inner member extends between the annular outer member and the one or more support members. The one or more support members can be radial support members. The porous inner member can be a screen. The frame of the porous member can be injection molded from plastic and the porous inner member can be a screen. The frame can further include a center support hub configured to deflect a jet of fluid.

The interior surface of the tubular member can have a substantially circular cross-section and include at least one region of reduced interior diameter. An exterior circumferential surface of a porous member can be positioned against a region of reduced interior diameter of the tubular member. The interior surface can include two regions of reduced interior diameter, including a first region of a first reduced interior diameter and a second region of a second reduced interior diameter, where the second reduced interior diameter is less than the first reduced interior diameter. The interior surface of the tubular member can have a substantially circular cross-section and the interior diameter can decrease from an inlet region toward an outlet region.

The tubular member can further include an inlet region and an outlet region. The outlet region can include an outlet plate that is positioned substantially perpendicular to a longitudinal axis of the tubular member and has an upper surface and a lower surface. The outlet plate can include an outlet opening extending through the outlet plate from the upper surface to the lower surface. An outlet member can be attached to the lower surface of the outlet plate and include an interior region forming an outlet passage, where the outlet passage is axially aligned with the outlet opening formed in the outlet plate. A first porous member can be positioned within the inlet region of the interior of the tubular member and a second porous member positioned within the outlet region of the interior of the tubular member.

The upper surface of the outlet plate can include a plurality of ribs extending from the interior surface of the tubular member toward the outlet opening, wherein the ribs are configured to support the second porous member. The lower surface of the outlet plate can include a plurality of ribs. Each of the plurality of ribs formed on the lower surface of the outlet plate can include a rib extending along at least a portion of a radius of the lower surface of the outlet plate. Alternatively, each of the plurality of ribs can include a rib extending across a width of at least a portion of the lower surface of the outlet plate.

A guard member can be attached to the lower surface of the outlet plate, the guard member including an interior region. The outlet member can be positioned within the interior region of the guard member. The lower surface of the outlet plate can include a plurality of ribs extending from an interior surface of the tubular member toward an exterior surface of the guard member attached thereto. The tubular member can be injection molded.

Implementations of the invention can realize one or more of the following advantages. The cartridge includes a collection area and an outlet member to direct fluid out of the cartridge, for example, into a collection vessel. Cartridges of varying length and diameter can have a uniformly sized and configured outlet member, which can be mated with a cartridge module or fluid connection. Having a uniform outlet member allows different sizes of cartridges to be used with a single cartridge module or fluid connection system. The outlet member is configured to provide a low connection force seal with exit fluid path, i.e., a user does not have to exert significant force to mate the outlet member to the exit fluid connection and create the seal. Twisting the cartridge to create a seal is not required, as is recommended if a luer fitting is used, thereby further facilitating connecting the cartridge to a fluid connection. Design tolerances can be relaxed due to the configuration of the sealing mechanism. Because an O-ring seal can be used against the substantially cylindrical outlet member, the location of the seal along the outlet member is not critical, allowing for some relaxation in axial design tolerances. By comparison, a luer fitting, for example, requires male and female luer parts be pressed tightly together, requiring more stringent axial design tolerances or compensation systems.

A guard member surrounding the outlet member protects the outlet member from damage, for example, if the cartridge is bumped or dropped. Ribs positioned on the upper surface of the outlet plate that support the lower porous member can keep the lower porous member from bowing under force into the collection area. Ribs formed along the lower surface of the outlet plate of the tubular member can create a strong bottom to resist internal pressures during a purification process, without excess stress on the outlet plate and limiting deflection to avoid disturbing the stationary phase within the cartridge. A conical outlet opening facilitates directing the flow of fluid from the cartridge into the outlet passage.

A textured surface, such as a knurled or stippled surface, or one or more circumferential ribs along the upper portion of the exterior surface of the cartridge provide a non-slip surface for a user to grip. The textured surface, projections or circumferential ribs can be configured to mate with corresponding features, e.g., grooves, formed on the interior of an outer annular member of a top head assembly of a cartridge module. When an axial force is exerted on the O-ring within the top head, the O-ring expands laterally causing a small increase in the outer diameter of the upper portion of the cartridge, which can cause the ribs on the cartridge to engage with the grooves in the top section. Engaging the ribs and grooves can increase the resistance of the assembly to separating due to the force of the internal pressure of the cartridge during a purification process.

Longitudinal ribs along the lower portion of the exterior surface of the cartridge can keep the cartridge from rolling. The ribs also add rigidity to the cartridge and can reduce or prevent bowing of the cartridge, for example, by increasing the bending moment of inertia of the cartridge. If the cartridge is formed from an injection molding process, the ribs can help plastic flow during the molding and can provide a surface to use when detaching the tubular member from a mandrel.

The tubular member and at least a portion, of the porous members can be formed from injection molding. Injection molding can provide a greater consistency of the interior diameter of the tubular member and a smoother internal surface, for example, as compared to an extruded tubular member. Spider lines, which are typical with a member formed by extrusion, can be avoided by injection molding. Injection molding the annular outer member and supports of the porous members can provide a better tolerance control on the exterior diameter of the porous members. Using a screen to create a porous member, as compared to, for example, a sentered porous plastic disk, can improve the quality of the porous members, e.g., due to there being fewer extractables. The porous member can have an overall smaller depth and therefore the total length of the cartridge can be smaller. Injection molding the annular outer member can provide a smoother surface that contacts the internal surface of the tubular member.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A shows a compression module.

FIG. 1B shows a chromatography cartridge.

FIGS. 2A and 2B show schematic representations of chromatography systems.

FIG. 3 shows a perspective view of a chromatography cartridge.

FIG. 4 shows a perspective, longitudinal cross-sectional view of a chromatography cartridge.

FIG. 5 shows a perspective view of a porous member.

FIGS. 6A-C show longitudinal cross-sectional views of three alternative tubular members of a chromatography cartridge.

FIG. 7 shows an exploded view of a porous member and a portion of a tubular member of a chromatography cartridge.

FIG. 8A shows a perspective, longitudinal cross-sectional view of a tubular member of a chromatography cartridge.

FIG. 8B shows a longitudinal cross-sectional view of an enlarged portion of a tubular member of a chromatography cartridge.

FIG. 9A shows a perspective view of the bottom of a chromatography cartridge.

FIG. 9B shows a bottom view of a chromatography cartridge with an alternative ribbing configuration.

FIG. 10 shows a chromatography cartridge attached to a cartridge module.

FIG. 11 is a flowchart showing a process for using a chromatography cartridge to purify a sample.

FIG. 12 shows a side view of a chromatography cartridge.

FIG. 13A shows a tubular member with an upper portion including protruding, angled ridges.

FIG. 13B shows a schematic representation of a plan view of an upper portion of a tubular member included angled ridges.

FIGS. 14A-C show a top head assembly configured to mate with the tubular member of FIG. 13A.

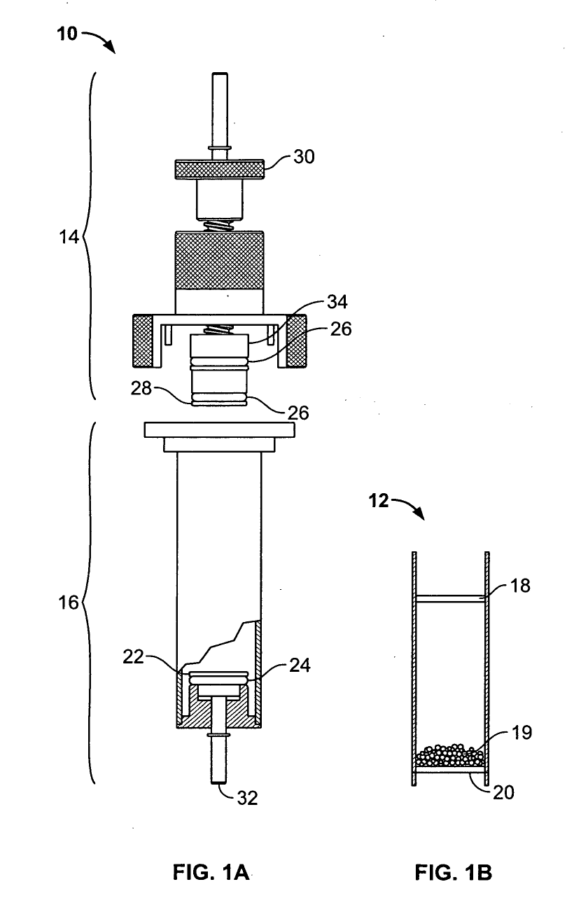

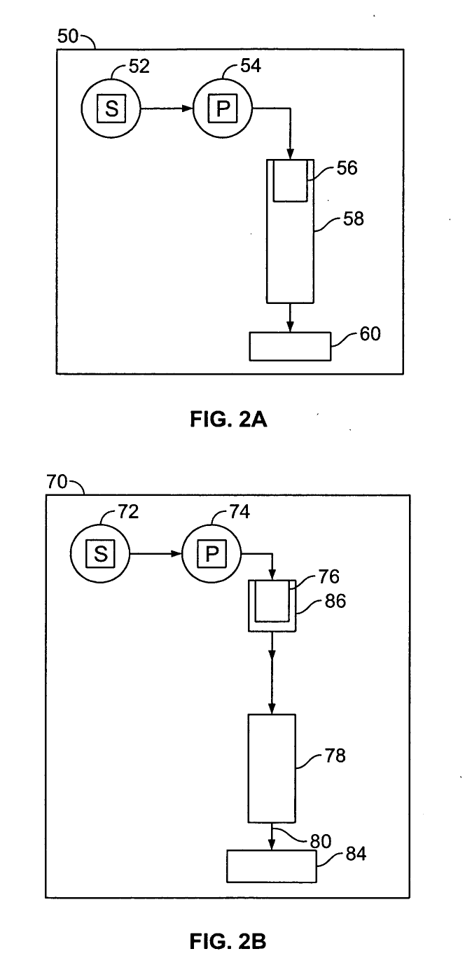

Like reference symbols in the various drawings indicate like elements.

### DETAILED DESCRIPTION

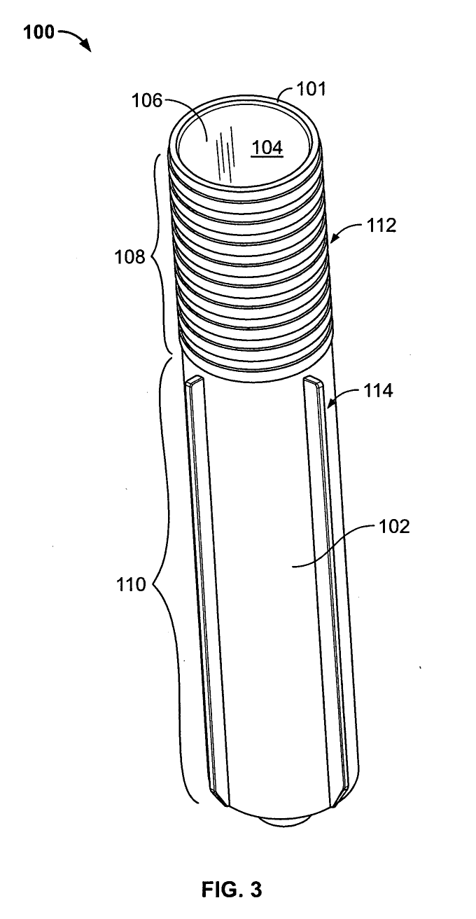

FIG. 3 shows a chromatography cartridge 100 that can be used in a purification process including, for example, a liquid chromatography operation, a scavenging operation or a reaction process. The cartridge 100 can be used in one of the exemplary chromatography systems described above or another purification system. The cartridge 100 includes a substantially tubular member 101 having an exterior surface 102 and an interior surface 104 that forms an interior region 106. The exterior surface 102 can have an upper portion 108 and a lower portion 110, where the upper portion includes ribs 112 arranged circumferentially about at least a portion of the exterior surface and the lower portion includes ribs 114 arranged longitudinally along at least a portion of the length of the lower portion 110 of the exterior surface 102.

The circumferential ribs 112 can provide a non-slip surface for a user to grip when handling the cartridge 100. Alternatively, the upper portion can include a textured surface, such as a knurled surface, stippled surface or surface with projections of some sort, to provide a non-slip gripping surface. The longitudinal ribs 114 can provide rigidity to the cartridge 100, for example, to prevent bowing of the tubular member 101. The longitudinal ribs 114 can also keep the cartridge 100 from rolling, for example, when placed horizontally on a surface such as a lab workbench.

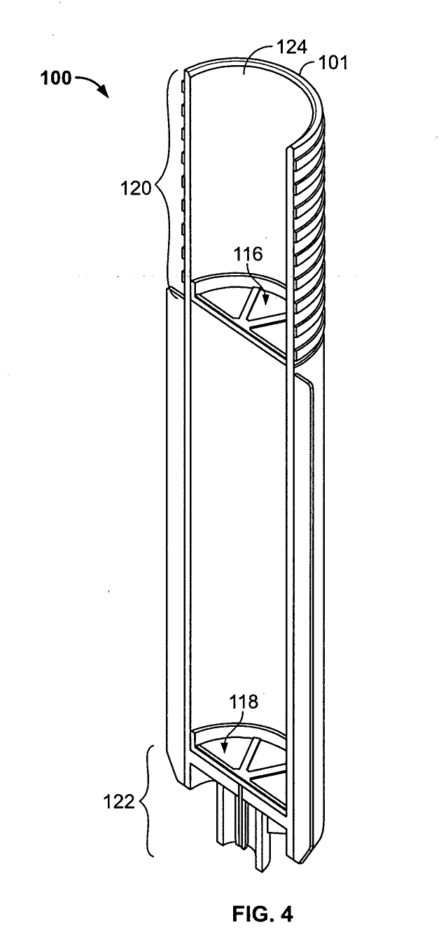

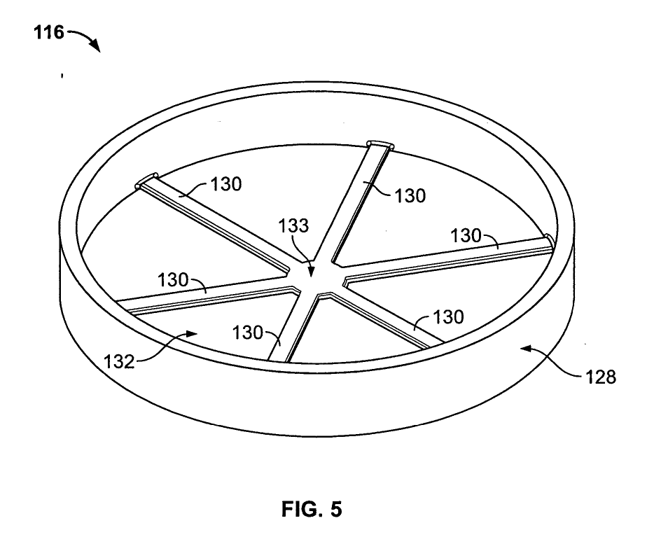

FIG. 4 shows a perspective, cross-sectional view of the cartridge 100, including upper and lower porous members 116, 118 positioned within the tubular member 101. The upper porous member 116 is positioned within an inlet region 120 of the tubular member 101, and the lower porous member 118 is positioned within an outlet region 122. In the embodiment shown, the upper porous member 116 is positioned to provide space for a sample module (not shown) to be inserted into the inlet region 120 above the upper porous member 116. In an alternative embodiment, the upper porous member 116 can be positioned closer to the inlet end 124 of the tubular member 101, for example, if a sample module will not be used. Other configurations of the porous members can be used, e.g., a porous member can be approximately as thick as the member is wide.

FIG. 5 shows one embodiment of a porous member, which for illustrative purposes is shown as the upper porous member 116. The porous member 116 includes a frame having a substantially annular outer member 128 and one or more radial support members 130. A porous material 132 extends between the annular outer member 128 and the radial support members 130. In one embodiment, the porous material 132 is a screen. For example, a screen can be formed from woven threads of 316 stainless steel screen. In one embodiment, the screen includes 325 threads per inch in one direction and 2300 threads per inch in a perpendicular direction, creating openings approximately 2 microns wide. The porous member 116 shown includes 6 radial support members 130. More or fewer radial support members 130 can be included. Alternatively, support members of a different configuration can be used, for example, lateral supports of differing length extending across the width of the porous member. Other embodiments of porous members can be used, for example, a disk-shaped polyethylene porous plate. The center support hub 133 can deflect a jet of fluid, eliminating a “jetting effect” and spreading out the flow of fluid more evenly through the porous member and cartridge 100.

The upper and lower porous members 116, 118 can be mounted to the interior surface 104 of the tubular member 101 by a friction fit, an adhesive, one or more mounting screws, ultrasonic or heat welding, or a combination of the above or using another convenient technique. In one embodiment, the interior diameter of the tubular member 101 includes regions of reduced diameter, so as to provide a friction fit surface against which to mount the upper and lower porous members 116, 118, permitting the porous members 116, 118 to be positioned in the tubular member 101 without having to force them through the full length of the interior region 106.

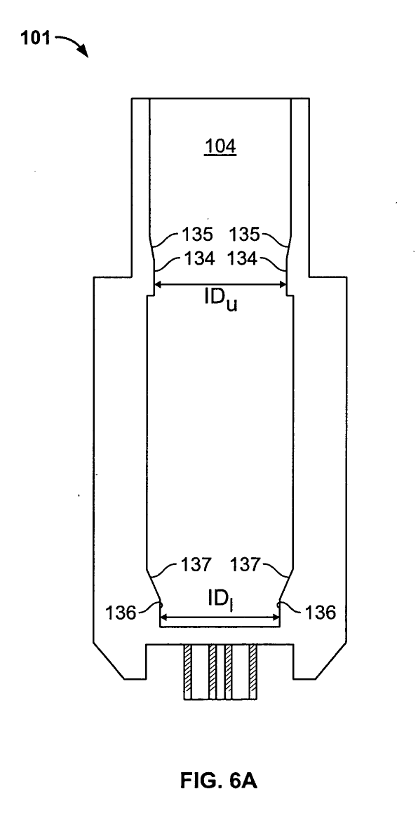

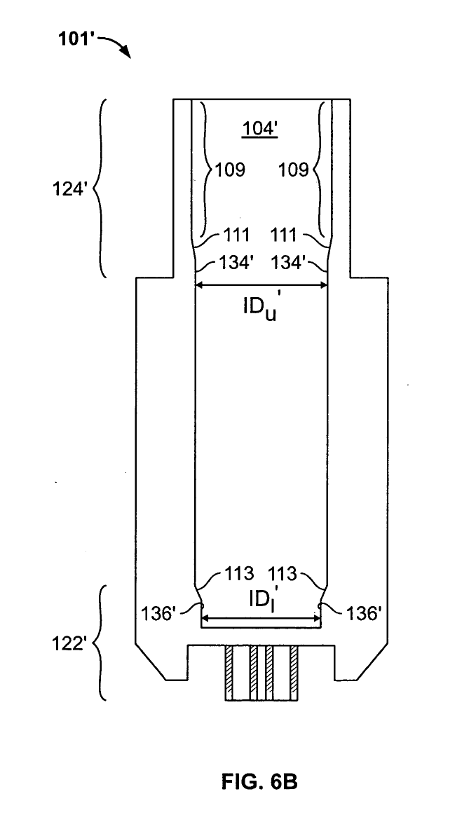

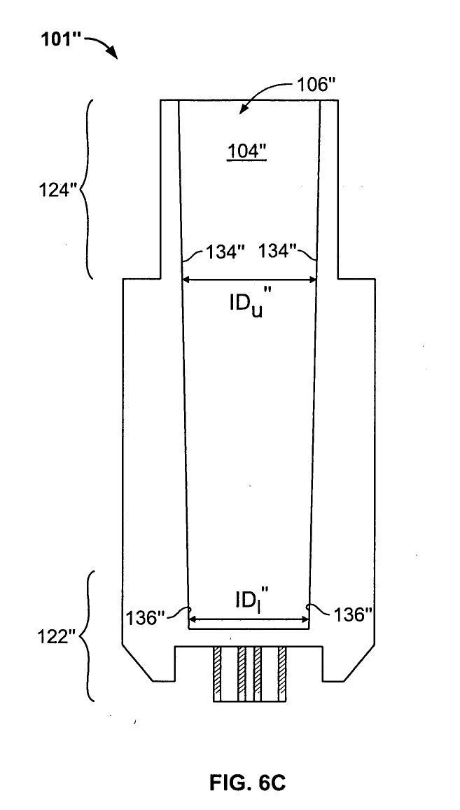

FIG. 6A shows a cross-sectional view of the tubular member 101. The interior surface 104 includes an upper region of reduced diameter 134 having interior diameter IDᵤ and a lower region of reduced diameter 136 having interior diameter ID₁. The diameter can be reduced by a relatively small amount. For example, for a tubular member 101 having an interior diameter of approximately 1.57 inches, the interior diameter can be reduced approximately 0.005 to 0.010 of an inch. The exterior diameter of the upper and lower porous members 116, 118 is configured so as to friction fit within the corresponding region of reduced diameter 134, 136. An angled lead-in region 135, 137 at each region of reduced diameter 134, 136 can facilitate insertion of the porous members 116, 118.

In one embodiment, the lower region of reduced diameter 136 can have a smaller diameter than the upper region of reduced diameter 134. That is, ID₁ is less than IDᵤ. The exterior diameter of the lower porous member 118 is less than the exterior diameter of the upper porous member 116 by an amount approximately corresponding to the difference between IDᵤ and ID₁. The lower porous member 118 can therefore pass through the upper region of reduced diameter 134 without interference as the lower porous member 118 is moved into position in the lower region of reduced diameter 136.

Referring to FIG. 6B, in another embodiment of a tubular member 101′, the diameter of the interior surface 104′ can be stepped to provide upper and lower regions of reduced diameter 134′ and 136′. For example, the interior diameter can be substantially constant in an upper section 109 of the interior. A short taper 111 can then be provided that leads into the upper region of reduced diameter 134′. Continuing down the interior, the reduced diameter can be maintained until a second short taper 113 is provided that leads into the lower region of reduced diameter 136′. The reduced diameter can continue until the end of the interior region of the tubular member 101′.

Referring to FIGS. 4 and 6C, in another embodiment of a tubular member 101″, the diameter of the interior surface 104″ can be slightly tapered, so as to gradually reduce from the inlet end 124″ toward the outlet region 122″. An upper region of reduced diameter 134″ has interior diameter IDᵤ″ and a lower region of reduced diameter 136″ has interior diameter ID₁″. The exterior diameter of the upper and lower porous members 116, 118 can be configured such that the upper porous member 116 can friction fit against the interior surface at the upper region of reduced diameter 134″, and the lower porous member 118 can be passed through the interior region 106″ until friction fitting against the interior surface at the lower region of reduced diameter 136″.

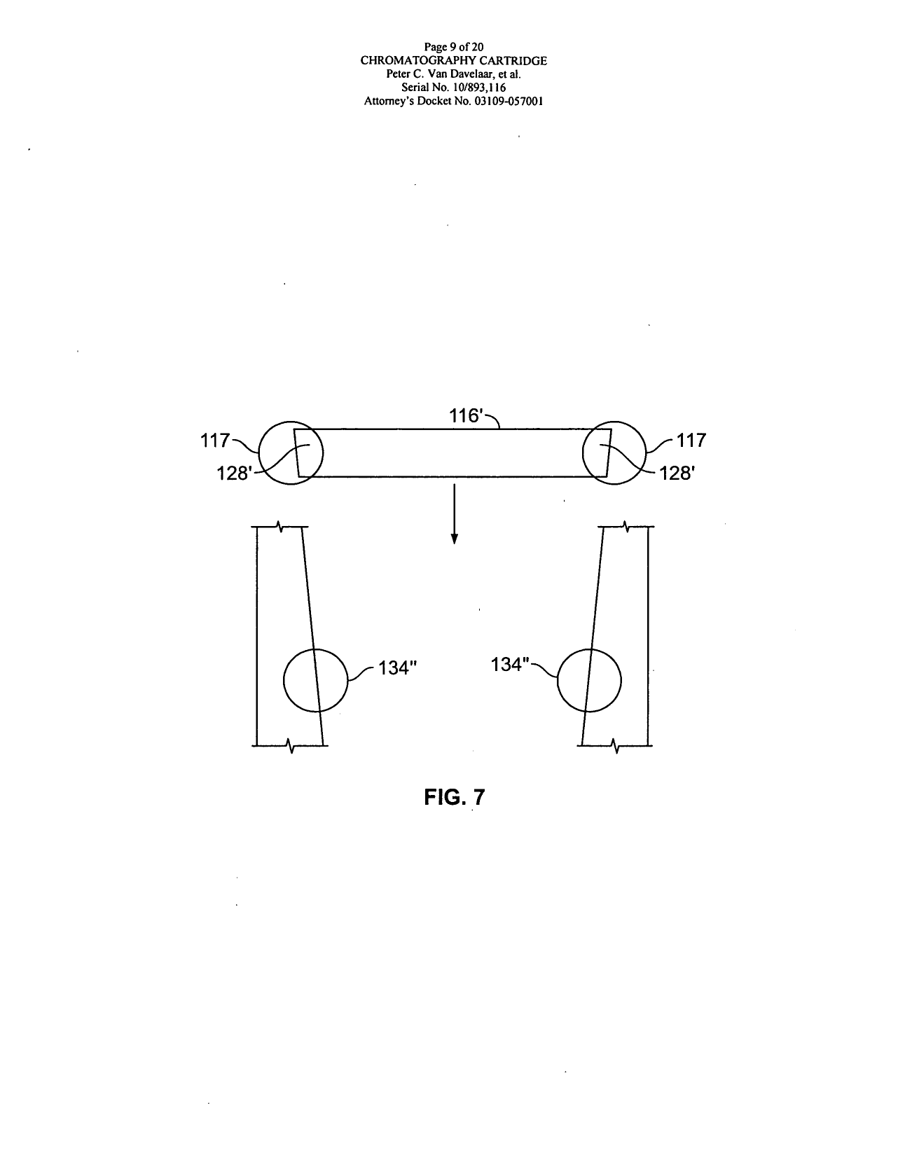

Referring to FIG. 7, to provide a better seal between the interior surface 104″ of the tubular member 101″ and the exterior surface of the porous members 116, 118, the annular outer member 128′ can be tapered so as to substantially correspond to the taper of the interior surface at the desired location in the inlet and outlet regions respectively. For example, a cross-sectional view of a porous member 116′ is shown. The annular outer member 128′ has a tapered profile as shown at 117. The tapered profile corresponds to the tapered profile of the interior surface 104″ of the tubular member 101″, so as to provide a friction fit at the upper region of reduced diameter 134″.

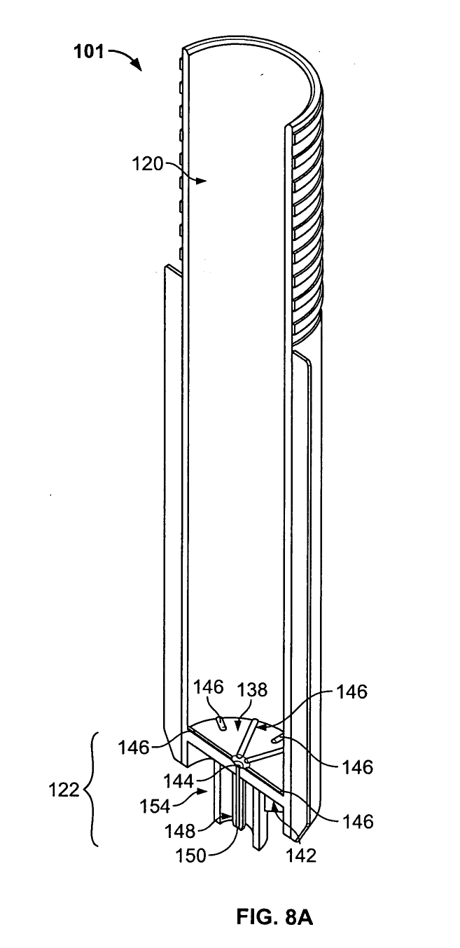

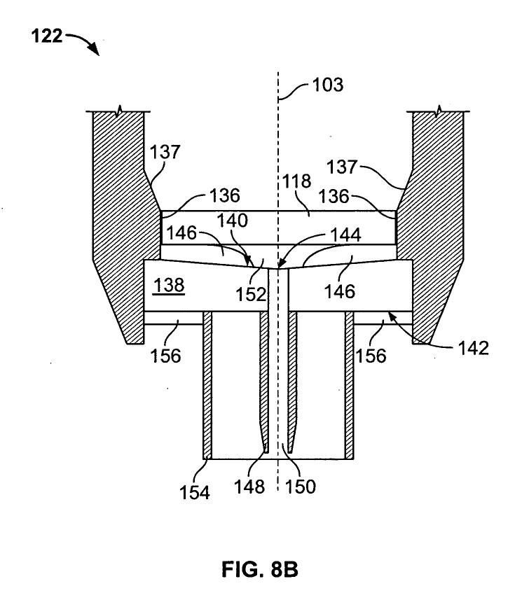

FIG. 8A shows a perspective, cross-sectional view of the tubular member 101. FIG. 8B shows an enlarged cross-sectional view of the outlet region 122 of the tubular member 101. The outlet region 122 includes an outlet plate 138 that is positioned substantially perpendicular to the longitudinal axis 103 of the tubular member 101. The outlet plate 138 has an upper surface 140 and a lower surface 142. An outlet opening 144 extends through the outlet plate 138 from the upper surface 140 to the lower surface 142. The outlet opening 144 can be conical to promote fluid flow through the opening 144. One or more ribs 146 can be included on the upper surface 140. The ribs 146 can provide support for the lower porous member 118, which can be positioned directly above the outlet plate 138. The outlet plate 138 can be formed integrally with the tubular member 101, or alternatively, can be formed separately and attached to the tubular member 101, for example, using ultrasonic welding, heat welding, hot air or hot plates joining techniques.

An outlet member 148 can be attached to or formed integrally with the lower surface 142. The outlet member 148 includes an interior region forming an outlet passage 150 that is axially aligned with the outlet opening 144. In one implementation the interior region is substantially cylindrical. The outlet member 148 includes a substantially cylindrical exterior surface and can have a tapered end. Solvent that is introduced into the chromatography cartridge 100 can thereby pass through the interior region 106, i. e., through the upper porous member 116, the stationary phase and the lower porous member 118, into a collection area 152 formed between the lower porous member 118 and the outlet plate 138. The solvent flows from the collection area 152 through the outlet opening 144 and passes into the outlet passage 150. The outlet passage 150 can be connected to a collection vessel, e.g., via a bottom head of a cartridge module (discussed below).

A guard member 154 can also be attached to or formed integrally with the lower surface 142 of the outlet plate 138. The guard member 154 is configured to protect the outlet member 148, for example, from damage when handling the cartridge 100. In one embodiment, the guard member 154 is substantially cylindrical with a hollow interior region that surrounds the outlet member 148 and is slightly longer than the outlet member 148.

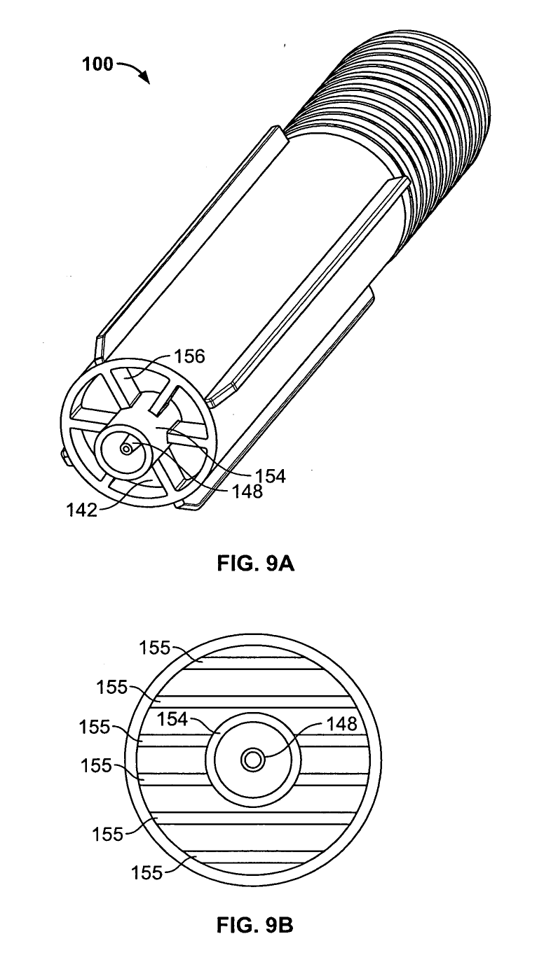

FIG. 9A shows a perspective view of the bottom of the cartridge 100. The guard member 154 and outlet member 148 are shown extending from the lower surface 142 of the outlet plate 138. Optionally, support ribs, such as the radial support ribs 156 shown, can be included on the lower surface 142 of the outlet plate 138 to provide increased rigidity to the outlet region 122 of the cartridge 100. Other configurations of support ribs can be used, for example, lateral support ribs 155 extending the width of the lower surface 142 of the outlet plate 138, as shown in an alternate bottom view in FIG. 9B. The exterior end of the substantially cylindrical outlet member 148 can be tapered to provide a snug fit into a connector, such as a flexible tube, to connect the cartridge to a collection vessel. The tapered end of the outlet member 148 can also allow necessary compression of seals, such as O-rings, used to create a seal about the outlet member 148.

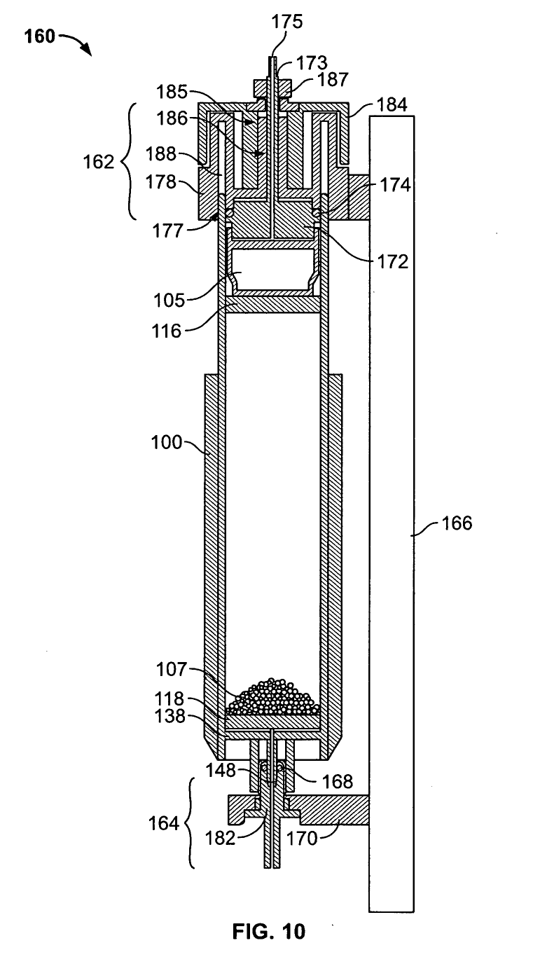

The cartridge 100 can be used with a cartridge module, for example, the cartridge module 160 shown in FIG. 10 including a top head assembly 162, a bottom head assembly 164 and one or more axial restraints 166 between the two assemblies 162, 164. In the embodiment of the cartridge module 160 shown, the top head assembly 162 and bottom head assembly 164 are attached to an axial restraint 166, which can be, in one embodiment, part of a piece of equipment. For example, the one or more axial restraints 166 may be one or more structural components of the equipment, and the top and bottom head assemblies 162, 164 may be cantilevered off of the equipment. In other embodiments, the cartridge module 160 can be a standalone assembly, and the one or more axial restraints can be formed from a solid tube extending between the top head assembly 162 and the bottom head assembly 164, or alternatively, one or more lateral members can extend between the top head assembly 162 and the bottom head assembly 164, leaving the cartridge substantially exposed. Whatever the configuration of the one or more axial restraints 166 may be, relative axial movement can be permitted between the top head assembly 162 and the bottom head assembly 164.

The bottom head assembly 164 includes a base 170 attached to the axial restraint 166. A contact member 182 is attached to the base 170, which contact member 182 supports a compressible seal 168, such as an O-ring. The contact member 182 is configured to mate with the outlet member 148 of the cartridge 100 and can fit between the outlet member 148 and the guard member 154. The contact member 182 can have a substantially cylindrical interior region to receive the outlet member 148 of the cartridge 100. The base 170 can be spring loaded (spring not shown), such that a spring urges the base 170 in a direction toward the top head assembly 162. The spring force should be greater than the force exerted against the bottom head assembly 164 by the internal pressure of the chromatography column 100 during a chromatography operation, otherwise the internal pressure may force the bottom head assembly 164 to separate from the chromatography column 100.

Although the bottom head assembly 164 is attached to the axial restraint 166, because the bottom head assembly 164 may still move axially, different lengths of chromatography columns 100 can be accommodated by the cartridge module 160. As long as the chromatography column 100 has an outlet member 148 configured to mate with the contact member 182, the chromatography column 100 can be sealed to the bottom head assembly 164.

The top head assembly 162 includes an upper head 172 supporting a compressible seal 174, such as an O-ring. A lower surface of the upper head 172 abuts an upper surface of the sample module 105, or can directly abut the upper surface of the upper porous member 116, in the absence of a sample module 105. The upper head 172 includes a passage 175 formed through the upper head 172, including through a shaft 173 forming an upper portion of the upper head 172. Fluid can be introduced into the chromatography column 100 through the passage 175.

The top head assembly 162 further includes a knob assembly 184 that can be rotated to seal the top head assembly 162 to the cartridge 100. The knob assembly 184 includes an annular component 185 having a threaded inner surface. The threaded inner surface of the annular component 185 mates with a threaded outer surface of a sleeve 186 positioned about the exterior of the shaft 173 of the upper head 172. When the knob assembly 184 is rotated, the threading action between the annular component 185 and the sleeve 186 causes the knob assembly 184 to move upwardly and exert an upwardly force against a collar 187 affixed to the shaft 173 of the upper head 172. The force causes the shaft 173 and the balance of the upper head 172 to move upwardly, thereby compressing the seal 174. Other configurations can be used to compress the seal 174.

In one embodiment, the circumferential ribs 112 formed on the exterior surface 102 of the upper portion 108 of the tubular member 101 can be configured to engage corresponding grooves formed in the inner surface 177 of an outer annular member 178 connected to the sleeve 186. When the compressible seal 174 is compressed, the seal 174 expands laterally causing a small increase in the outer diameter of the upper portion 108 of the cartridge 100, which can cause the circumferential ribs 112 on the cartridge 100 to engage with the grooves in the outer annular member 178. Engaging the circumferential ribs 112 and grooves can increase the resistance of the assembly to separating due to the force of the internal pressure of the cartridge 100 during a purification process.

In another embodiment, the circumferential ribs 112 formed on the exterior surface 102 of the tubular member 101 can extend only partially around the circumference of the tubular member 101 at intervals. For example, the ribs can extend approximately 80-90° around the circumference on opposite sides of the tubular member 101 (i.e., at 0-90° and at 180-270° about the circumference). The partial circumferential ribs 112 can be used to create a lock between the tubular member 101 and the top head assembly 162 when the cartridge 100 is rotated approximately 90°.

The top head assembly 162 is affixed to the axial restraint 166. The top head assembly 162 can be used with the chromatography column 100 without the sample module 105. The configuration of the top head assembly 162 includes a space 188 between the outer annular member 178 and the interior components, such that in the absence of the sample module 105 the chromatography column 100 can be positioned with the upper surface of the porous member 116 abutting the lower surface of the upper head 172.

The embodiment of the cartridge module 160 shown includes a bottom head assembly 164 that is spring-loaded in an upwardly direction (the slide and spring mechanism are not shown). Alternatively, the top head assembly 162 can be spring loaded downwardly, or both top and bottom head assemblies 162, 164 can be axially movable. The top and bottom head assemblies 162, 164 can also be lockable in any given position.

Referring to FIGS. 3, 4, 6A and 11, an exemplary process 200 for purifying a sample using the cartridge 100 and the cartridge module 160 is shown. The lower porous member 118 is inserted into the interior region 106 of the tubular member 101 and friction fit against the interior surface 104 in the lower region of reduced diameter 136 (step 202). The interior region 106 is partially filled with a stationary phase 107, such as a silica, leaving room for the upper porous member 116 and sample module 105 (step 204). The upper porous member 116 is inserted into the interior region 106 and friction fit against the interior surface 104 in the upper region of reduced interior diameter 134 (step 206). The sample module 105 is inserted into the interior region 106 to abut the upper surface of the upper porous member 116 (step 208). The cartridge 100 is inserted into the bottom head assembly 164 (step 210). The cartridge 100 is attached to the top head assembly 162 (step 212). Inserting the cartridge 100 into the bottom head assembly 164 can be as simple as a user positioning the outlet member 148 of the cartridge 100 over the contact member 182 of the bottom head assembly 164 and pushing the contact member 182 onto the outlet member 148. The spring loaded action of the bottom head assembly 164 can be used as follows: push the bottom head assembly 164 downward using the cartridge 100, relax the downward force on the cartridge 100, allow the bottom head assembly to move upwardly, and thereby insert the cartridge 100 into the top head assembly 162.

The sealing mechanism is activated to create a seal between the cartridge and the top head assembly 162 (step 214). For example, in the embodiment shown, a user can rotate the knob assembly 184 on the top head assembly 162 to compress the compressible seal 174. Once a seal is created, the purification process is initiated (step 216), for example, by pumping a solvent through a passage 175 in the top head assembly 162 and into the cartridge 100.

In one implementation, steps 202-206 may be performed at a facility manufacturing the cartridge 100, and steps 208-216 may be performed by a user of the cartridge 100, for example, in a laboratory.

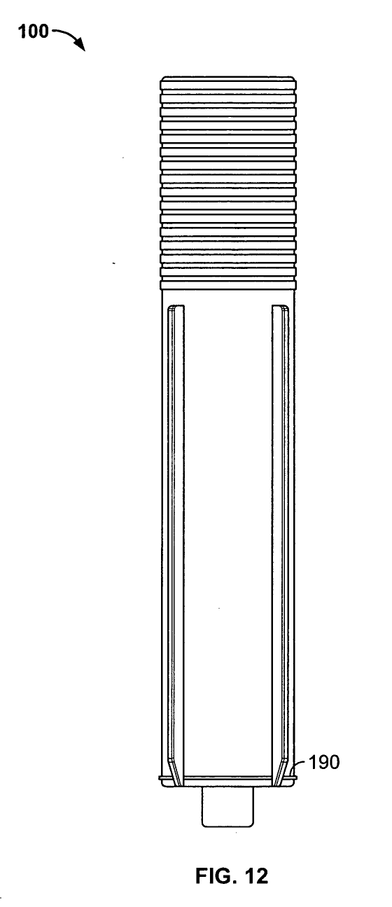

Referring to FIG. 12, in one embodiment, the chromatography column 100 can include a ridge 190 formed along all or a portion of the circumference of exterior surface 102 of the column 100. The ridge 190 provides a feature that the bottom head assembly 164 can be configured to connect to, in order to maintain a seal and connection between the bottom head assembly 164 and the column 100 during a chromatography operation. The ridge 190 is shown near the bottom of the column 100, however, alternative configurations can be used. For example, the ridge 190 can be on the inside of the tubular member 101, or on the outside of the guard member 154. Configurations other than a ridge can also be used, such as grooves or holes, so long as the configuration provides a feature that can connect to the bottom head assembly 164.

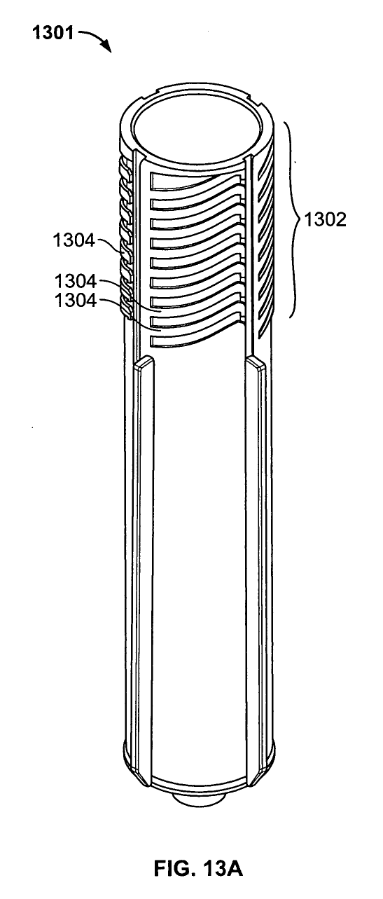

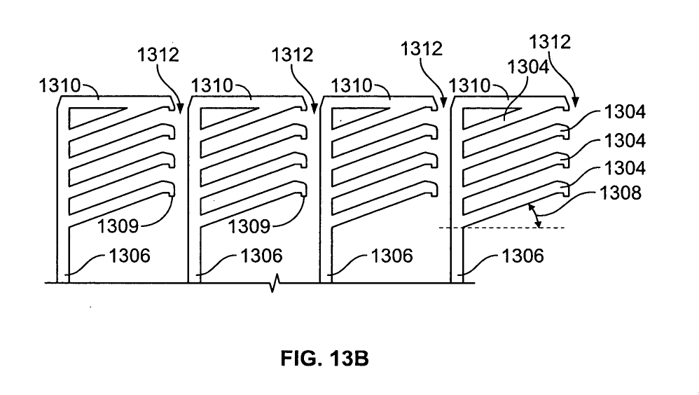

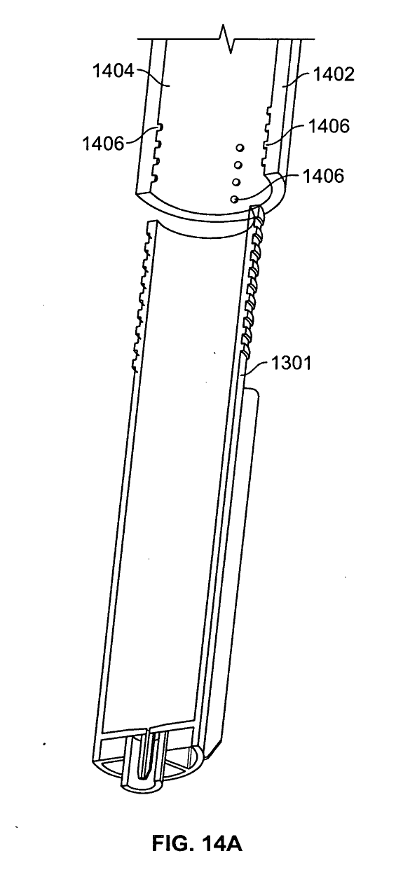

FIGS. 13A and 13B show another embodiment of an upper portion 1302 of an exterior surface of a tubular member 1301. The upper portion 1302 includes projections protruding from the exterior surface. For illustrative purposes, FIG. 13B shows a plan view of the projections if the exterior surface of the upper portion 1302 were laid flat (although FIG. 13B shows a slightly different embodiment, as described below). The projections include angled ridges 1304 that extend a portion (e.g., a quarter) of the circumference of the tubular member 1301 at an angle of inclination 1308. In one embodiment the angle of inclination 1308 is approximately 19°, although a lesser or greater angle can be used. The projections also include vertical ridges 1306, each vertical ridge forming a “backbone” for a set of the angled ridges 1304. Additionally, a horizontal ridge 1310 can be included at the upper end of each set of angled ridges 1304.

Vertical passages 1312 are formed between the sets of angled ridges 1304, with one edge of the vertical passage 1312 formed by a vertical ridge 1306. In the embodiment shown, there are four sets of angled ridges 1304, however, in other embodiments there can be more or fewer sets of angled ridges 1304. In the embodiment shown in FIG. 13A, each set of angled ridges 1304 includes 8 angled ridges 1304, whereas in the embodiment shown in FIG. 13B, each set of angled ridges includes 4 angled ridges 1304. More or fewer angled ridges 1304 can be included per set.

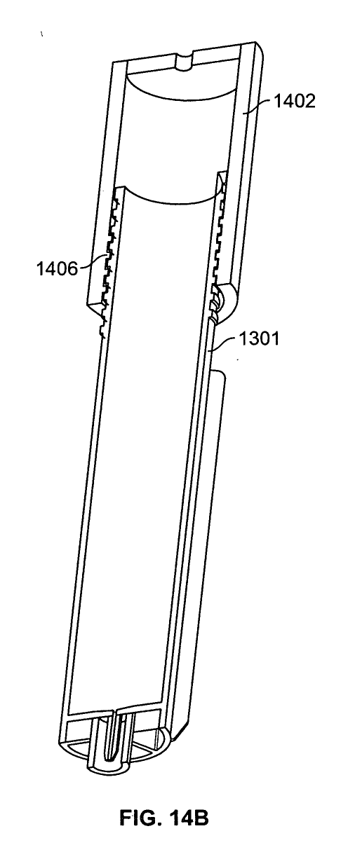

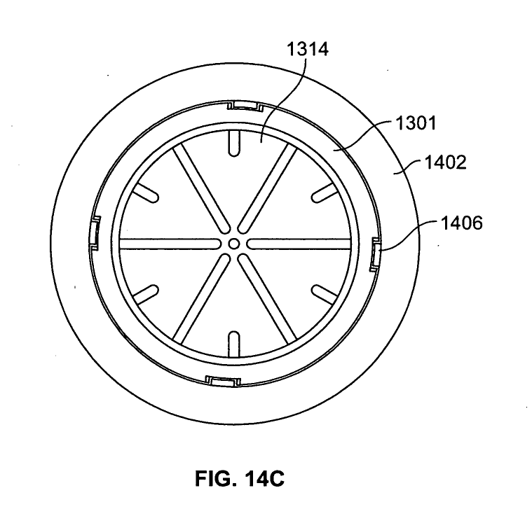

Referring to FIGS. 14A-C, a top head assembly 1402 of one implementation of a cartridge module that can mate with the tubular member 1301 during a purification process is shown. An interior surface 1404 of the top head assembly 1402 includes protruding pins 1406. There are four sets of pins 1406 (only three are shown) that are arranged at equidistant intervals about the circumference of the interior of the top head assembly 1402. The pins 1406 are configured to fit within the vertical passages 1312 formed on the exterior surface of the tubular member 1301 when the tubular member 1301 is inserted into the top head assembly 1402. A user can then rotate the top head assembly 1402 relative to the tubular member 1301, forcing the pins 1406 into a space formed between two of the angled ridges 1304. The angle of inclination 1308 of the angled ridges 1304 forms a lead-in angle, facilitating insertion of the pins 1406 into the spaces formed between the angled ridges 1304. Nubs 1312 formed on the ends of the angled ridges 1304 can keep the pins 1406 within the space formed between two of the angled ridges 1304, thereby locking the tubular member 1301 to the top head assembly 1402.

FIG. 14B shows a cut-away view of the top head assembly 1402 mated with the tubular member 1301. FIG. 14C shows a top cross-sectional view of the top head assembly 1402 connected to the tubular member 1301 including an upper porous member 1314. Pins 1406 protruding from the interior surface of the top head assembly 1402 are shown aligned with vertical passages 1312 formed on the exterior surface of the tubular member 1301, before the top head assembly 1402 and tubular member 1301 have been rotated relative to one another to position the pins 1406 within spaces formed between the angled ridges 1304.

In the embodiment shown in FIGS. 14A-C, there is one set of pins 1406 for each vertical passage 1312 formed on the exterior of the cartridge 100. However, in other embodiments, there can be fewer sets of pins 1406 than vertical passages 1312. Additionally, in the embodiment shown in FIGS. 14A-C, there is one pin in each set of pins 1406 corresponding to the number of spaces formed between the angled ridges 1304 in each set of angled ridges 1304 formed on the exterior of the cartridge 100. More or fewer pins 1406 per set can be used, however, by increasing the number of pins 1406, the force on the pins 1406 can be spread out over a larger contact area, minimizing the force exerted on any one pin 1406. The horizontal and vertical ridges 1310, 1306 formed on the exterior of the cartridge 100 can assist an operator in guiding the pins 1406 into position when connecting the cartridge 100 to the top head assembly 162.

The tubular member, including the various embodiments described above, as well as the annular outer member 128 and radial support members 130 of the porous members, can be manufactured from materials including plastics and metals. Injection molding can be used to fabricate the tubular member 101, annular outer member 128 and radial support members 130 using materials such as polypropylene, polyethylene, Ultem, Valox, or Teflon. Although other fabrication techniques can be used, injection molding can provide a greater consistency of the interior diameter of the tubular member 101 and a smoother interior surface 104, for example, as compared to an extruded tubular member. Spider lines, which are typical with a member formed by extrusion, can be avoided by injection molding. Injection molding the annular outer member 128 and the radial support members 130 of the porous members can provide a better tolerance control on the exterior diameter of the porous members. Using a screen in the porous members, as compared to, for example, a porous plastic disk, can improve the quality of the-porous members, e.g., due to there being fewer extractables. The screen can be molded into place during the injection molding process. The screen used in the porous members can be, in one embodiment, formed from threads of 316 stainless steel.

In one embodiment, the tubular member can have approximately the following dimensions:

interior diameter=1.57 inches;

exterior diameter=1.84 inches;

distance between lower surface of upper porous member and upper surface of lower porous member (bed length)=5.9 inches; and

total length=9 inches.

In one embodiment, a porous member can have approximately the following dimensions:

exterior diameter=1.58 inches;

thickness=0.25 inches

The use of terminology such as “upper” and “lower” throughout the specification and claims is for illustrative purposes only, to distinguish between various components of the cartridge. The use of “upper” and “lower” does not imply a particular orientation of the cartridge. For example, the upper surface of the outlet plate can be orientated above, below or beside the lower surface of the outlet plate, and visa versa, depending on whether the cartridge is positioned vertically upwards, vertically downwards or horizontally.

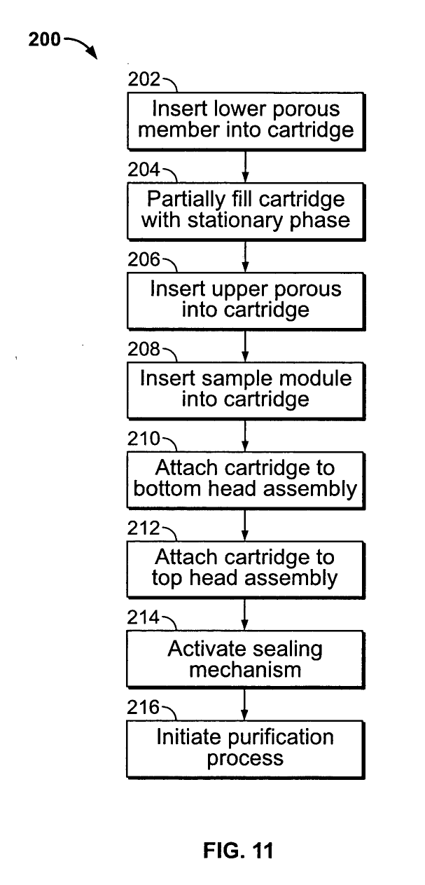

A number of embodiments of the invention have been described. Nevertheless, it will be understood that various modifications may be made without departing from the spirit and scope of the invention. The logic flow depicted in FIG. 11 does not have to be performed in the order shown, or in a sequential order, and the steps of the invention can be performed in another order and still achieve desirous results. Accordingly, other embodiments are within the scope of the following claims.

What is claimed is:

1. An apparatus comprising:
a tubular member having an interior surface forming an interior region and an exterior surface, the exterior surface including one or more longitudinal ribs protruding from the exterior surface along at least a portion of the length of the exterior surface; and
at least one porous member fitted within the interior region of the tubular member.

2. The apparatus of claim 1, wherein the at least one porous member is orientated substantially perpendicular to a longitudinal axis of the tubular member and in contact with the interior surface of the tubular member.

3. The apparatus of claim 1, wherein the exterior surface of the tubular member comprises:
an upper portion including one or more projections protruding from the exterior surface.

4. The apparatus of claim 3, wherein the one or more projections comprise one or more ribs protruding from the exterior surface around all or a portion of the circumference of the exterior surface.

5. The apparatus of claim 1, wherein the exterior surface of the tubular member comprises:
a lower portion, wherein the one or more longitudinal ribs extend the length of the lower portion.

6. The apparatus of claim 1, wherein a porous member comprises:
a frame having an annular outer member; and
a porous inner member.

7. The apparatus of claim 6, wherein the porous member further comprises one or more support members and the porous inner member extends between the annular outer member and the one or more support members.

8. The apparatus of claim 7, wherein the one or more support members are radial support members.

9. The apparatus of claim 6, wherein the porous inner member comprises a screen.

10. The apparatus of claim 6, wherein the frame of a porous member is injection molded from plastic and the porous inner member comprises a screen.

11. The apparatus of claim 1, wherein:
the interior surface of the tubular member has a substantially circular cross-section and includes at least one region of reduced interior diameter; and
an exterior surface of a porous member is positioned against a region of reduced interior diameter of the tubular member.

12. The apparatus of claim 11, wherein:
the interior surface includes two regions of reduced interior diameter, including a first region of a first reduced interior diameter and a second region of a second reduced interior diameter, where the second reduced interior diameter is less than the first reduced interior diameter.

13. The apparatus of claim 1, wherein:
the interior surface of the tubular member has a substantially circular cross-section and the interior diameter decreases from an inlet region toward an outlet region.

14. The apparatus of claim 1, the tubular member further comprising:
an inlet region and an outlet region, the outlet region comprising:
an outlet plate that is positioned substantially perpendicular to a longitudinal axis of the tubular member and having an upper surface and a lower surface, the outlet plate including an outlet opening extending through the outlet plate from the upper surface to the lower surface;
an outlet member attached to the lower surface of the outlet plate and including an interior region forming an outlet passage, where the outlet passage is axially aligned with the outlet opening formed in the outlet plate;
wherein a first porous member is positioned within the inlet region of the interior of the tubular member and a second porous member is positioned within the outlet region of the interior of the tubular member.

15. The apparatus of claim 14, wherein the upper surface of the outlet plate includes a plurality of ribs extending from the interior surface of the tubular member toward the outlet opening, wherein the ribs are configured to support the second porous member.

16. The apparatus of claim 14, further comprising:
a guard member attached to the lower surface of the outlet plate, the guard member including an interior region, where the outlet member is positioned within the interior region of the guard member.

17. The apparatus of claim 16, wherein the lower surface of the outlet plate includes a plurality of ribs extending from an interior surface of the tubular member toward an exterior surface of the guard member attached thereto.

18. The apparatus of claim 1, wherein the tubular member is injection molded.

19. An apparatus comprising:
a tubular member having an interior surface forming an interior region and an exterior surface; and
at least one porous member fitted within the interior region of the tubular member, the porous member including:
a frame having an annular outer member; and
a porous inner member comprising a screen.

20. The apparatus of claim 19, wherein the at least one porous member is orientated substantially perpendicular to a longitudinal axis of the tubular member and in contact with the interior surface of the tubular member.

21. The apparatus of claim 19, wherein the frame further comprises one or more support members and the porous inner member extends between the annular outer member and the one or more support members.

22. The apparatus of claim 21, wherein the one or more support members are radial support members.

23. The apparatus of claim 19, wherein the frame further comprises a center support hub configured to deflect a jet of fluid.

24. The apparatus of claim 19, wherein the frame of a porous member is injection molded from plastic and the screen is formed from stainless steel.

25. The apparatus of claim 19, wherein:
the interior surface of the tubular member has a substantially circular cross-section and includes at least one region of reduced interior diameter; and
an exterior surface of a porous member is positioned against a region of reduced interior diameter of the tubular member.

26. The apparatus of claim 19, wherein the exterior surface of the tubular member comprises:
an upper portion including one or more projections protruding from the exterior surface.

27. The apparatus of claim 26, wherein the one or more projections comprise one or more ribs protruding from the exterior surface around all or a portion of the circumference of the exterior surface.

28. The apparatus of claim 19, wherein the exterior surface of the tubular member comprises:
a lower portion including one or more longitudinal ribs protruding from the exterior surface.

29. An apparatus comprising:
a tubular member including:
an exterior surface;
an interior surface forming an interior region;
an inlet region; and
an outlet region, the outlet region comprising:
an outlet plate that is positioned substantially perpendicular to a longitudinal axis of the tubular member and having an upper surface and a lower surface, the outlet plate including an outlet opening extending through the outlet plate from the upper surface to the lower surface; and
an outlet member attached to the lower surface of the outlet plate, the outlet member including an interior region forming an outlet passage, where the outlet passage is axially aligned with the outlet opening formed in the outlet plate, and a substantially cylindrical exterior region with a tapered end.

30. The apparatus of claim 29, further comprising:
at least one porous member fitted within the interior region of the tubular member.

31. The apparatus of claim 30, wherein the apparatus includes at least two porous members and a first porous member is positioned within the inlet region of the interior of the tubular member and a second porous member is positioned within the outlet region of the interior of the tubular member.

32. The apparatus of claim 31, wherein the upper surface of the outlet plate includes a plurality of ribs extending from the interior surface of the tubular member toward the outlet opening, wherein the ribs are configured to support the second porous member.

33. The apparatus of claim 30, wherein a porous member comprises:
a frame having an annular outer member; and
an inner porous member.

34. The apparatus of claim 33, wherein the inner porous member comprises a screen.

35. The apparatus of claim 30, wherein:
the interior surface of the tubular member has a substantially circular cross-section and includes at least one region of reduced interior diameter; and
an exterior circumferential surface of a porous member is positioned against a region of reduced interior diameter of the tubular member.

36. The apparatus of claim 29, wherein the exterior surface of the tubular member comprises:
an upper portion including one or more projections protruding from the exterior surface.

37. The apparatus of claim 36, wherein the one or more projections comprise one or more ribs protruding from the exterior surface around all or a portion of the circumference of the exterior surface.

38. The apparatus of claim 29, wherein the exterior surface of the tubular member comprises:
a lower portion including one or more longitudinal ribs protruding from the exterior surface.

39. The apparatus of claim 29, further comprising:
a guard member attached to the lower surface of the outlet plate, the guard member including an interior region, where the outlet member is positioned within the interior region of the guard member.

40. The apparatus of claim 39, wherein the lower surface of the outlet plate includes a plurality of ribs extending from an interior surface of the tubular member toward an exterior surface of the guard member attached thereto.

41. An apparatus comprising:
a tubular member including:
an exterior surface;
an interior surface forming an interior region;
an inlet region; and
an outlet region, the outlet region comprising:
an outlet plate that is positioned substantially perpendicular to a longitudinal axis of the tubular member and having an upper surface and a lower surface, the outlet plate including an outlet opening extending through the outlet plate from the upper surface to the lower surface;
an outlet member attached to the lower surface of the outlet plate and including an interior region forming an outlet passage, where the outlet passage is axially aligned with the outlet opening formed in the outlet plate; and
a guard member attached to the lower surface of the outlet plate, the guard member including an interior region, where the outlet member is positioned within the interior region of the guard member.

42. The apparatus of claim 41, further comprising:
at least one porous member fitted within the interior region of the tubular member.

43. The apparatus of claim 41, wherein the apparatus includes at least two porous members and a first porous member is positioned within the inlet region of the interior of the tubular member and a second porous member is positioned within the outlet region of the interior of the tubular member.

44. The apparatus of claim 43, wherein the upper surface of the outlet plate includes a plurality of ribs extending from the interior surface of the tubular member toward the outlet opening, wherein the ribs are configured to support the second porous member.

45. The apparatus of claim 41, wherein the exterior surface of the tubular member comprises:
an upper portion including a one or more projections protruding from the exterior surface.

46. The apparatus of claim 45, wherein the one or more projections comprise one or more ribs protruding from the exterior surface around all or a portion of the circumference of the exterior surface.

47. The apparatus of claim 41, wherein the exterior surface of the tubular member comprises:
a lower portion including one or more longitudinal ribs protruding from the exterior surface.

48. The apparatus of claim 41, wherein a porous member comprises:
a frame having an annular outer member; and
an inner porous member.

49. The apparatus of claim 48, wherein the inner porous member comprises a screen.

50. The apparatus of claim 41, wherein:
the interior surface of the tubular member has a substantially circular cross-section and includes at least one region of reduced interior diameter; and
an exterior surface of a porous member is positioned against a region of reduced interior diameter of the tubular member.

51. The apparatus of claim 41, wherein the lower surface of the outlet plate includes a plurality of ribs extending from an interior surface of the tubular member toward an exterior surface of the guard member attached thereto.

52. An apparatus comprising:
a tubular member having an interior surface forming an interior region and an exterior surface, wherein the exterior surface includes one or more projections protruding from the exterior surface along at least a portion of the length of the exterior surface.

53. The apparatus of claim 52, wherein the one or more projections comprise one or more ribs protruding around all or a portion of the circumference of the exterior surface.

54. The apparatus of claim 52, wherein the exterior surface of the tubular member comprises:
an upper portion including the one or more projections; and
a lower portion including one or more longitudinal ribs protruding from the exterior surface.

55. The apparatus of claim 52, further comprising:
at least one porous member fitted within the interior region of the tubular member.

56. The apparatus of claim 55, wherein the at least one porous member is orientated substantially perpendicular to a longitudinal axis of the tubular member and in contact with the interior surface of the tubular member.

57. The apparatus of claim 56, wherein a porous member comprises:
a frame having an annular outer member; and
a porous inner member.

58. The apparatus of claim 57, wherein the porous member further comprises one or more support members and the porous inner member extends between the annular outer member and the one or more support members.

59. The apparatus of claim 58, wherein the porous inner member comprises a screen.

60. The apparatus of claim 55, wherein:
the interior surface of the tubular member has a substantially circular cross-section and includes at least one region of reduced interior diameter; and
an exterior surface of a porous member is positioned against a region of reduced interior diameter of the tubular member.

61. The apparatus of claim 52, wherein the tubular member is injection molded.

62. An apparatus comprising:
a tubular member having an interior surface forming an interior region and an exterior surface, where the interior surface of the tubular member has a substantially circular cross-section and includes at least one region of reduced interior diameter; and
at least one porous member fitted within the interior region of the tubular member, where an exterior surface of a porous member is positioned against the region of reduced interior diameter of the tubular member.

63. The apparatus of claim 62, wherein:
the interior surface includes two regions of reduced interior diameter, including a first region of a first reduced interior diameter and a second region of a second reduced interior diameter, where the second reduced interior diameter is less than the first reduced interior diameter; and
a first porous member is fitted within the first region of a first reduced interior diameter and a second porous member is fitted within the second region of a second reduced interior diameter.

64. The apparatus of claim 62, wherein the at least one porous member is orientated substantially perpendicular to a longitudinal axis of the tubular member and in contact with the region of reduced interior diameter of the interior surface of the tubular member.

65. The apparatus of claim 62, wherein the exterior surface of the tubular member comprises:
an upper portion including one or more projections protruding from the exterior surface.

66. The apparatus of claim 65, wherein the one or more projections comprise one or more ribs protruding from the exterior surface around all or a portion of the circumference of the exterior surface.

67. The apparatus of claim 62, wherein the exterior surface of the tubular member comprises:
a lower portion including one or more longitudinal ribs protruding from the exterior surface.

68. The apparatus of claim 62, wherein a porous member comprises:
a frame having an annular outer member; and
a porous inner member.

69. The apparatus of claim 68, wherein the porous member further comprises one or more support members and the porous inner member extends between the annular outer member and the one or more support members.

70. The apparatus of claim 69, wherein the one or more support members are radial support members.

71. The apparatus of claim 68, wherein the porous inner member comprises a screen.

72. The apparatus of claim 68, wherein the frame of a porous member is injection molded from plastic and the porous inner member comprises a stainless steel screen.

73. The apparatus of claim 62, the tubular member further comprising:
an inlet region and an outlet region, the outlet region comprising:
an outlet plate that is positioned substantially perpendicular to a longitudinal axis of the tubular member and having an upper surface and a lower surface, the outlet plate including an outlet opening extending through the outlet plate from the upper surface to the lower surface;
an outlet member attached to the lower surface of the outlet plate and including an interior region forming an outlet passage, where the outlet passage is axially aligned with the outlet opening formed in the outlet plate;
wherein a first porous member is positioned within the inlet region of the interior of the tubular member and a second porous member is positioned within the outlet region of the interior of the tubular member.

74. The apparatus of claim 73, wherein the upper surface of the outlet plate includes a plurality of ribs extending from the interior surface of the tubular member toward the outlet opening, wherein the ribs are configured to support the second porous member.

75. The apparatus of claim 73, further comprising:
a guard member attached to the lower surface of the outlet plate, the guard member including an interior region, where the outlet member is positioned within the interior region of the guard member.

76. The apparatus of claim 75, wherein the lower surface of the outlet plate includes a plurality of ribs extending from an interior surface of the tubular member toward an exterior surface of the guard member attached thereto.

77. An apparatus comprising:
a tubular member including:
an exterior surface;
an interior surface forming an interior region;
an inlet region; and
an outlet region, the outlet region comprising:
an outlet plate that is positioned substantially perpendicular to a longitudinal axis of the tubular member and having an upper surface and a lower surface, the outlet plate including:
an outlet opening extending through the outlet plate from the upper surface to the lower surface;
one or more ribs extending along at least a portion of the lower surface of the outlet plate; and
an outlet member attached to the lower surface of the, outlet plate and including an interior region forming an outlet passage, where the outlet passage is axially aligned with the outlet opening formed in the outlet plate.

78. The apparatus of claim 77, wherein each of the plurality of ribs comprise a rib extending along at least a portion of a radius of the lower surface of the outlet plate.

79. The apparatus of claim 77, wherein each of the plurality of ribs comprise a rib extending across a width of at least a portion of the lower surface of the outlet plate.

80. The apparatus of claim 77, further comprising:
at least one porous member fitted within the interior region of the tubular member.

81. The apparatus of claim 80, wherein the apparatus includes at least two porous members and a first porous member is positioned within the inlet region of the interior of the tubular member and a second porous member is positioned within the outlet region of the interior of the tubular member.

82. The apparatus of claim 81, wherein the upper surface of the outlet plate includes a plurality of ribs extending from the interior surface of the tubular member toward the outlet opening, wherein the ribs are configured to support the second porous member.

83. The apparatus of claim 80, wherein a porous member comprises:
a frame having an annular outer member; and
an inner porous member.

84. The apparatus of claim 83, wherein the inner porous member comprises a screen.

85. The apparatus of claim 80, wherein:
the interior surface of the tubular member has a substantially circular cross-section and includes at least one region of reduced interior diameter; and
an exterior surface of a porous member is positioned against a region of reduced interior diameter of the tubular member.

86. The apparatus of claim 77, wherein the exterior surface of the tubular member comprises:
an upper portion including one or more projections protruding from the exterior surface.

87. The apparatus of claim 86, wherein the one or more projections comprise one or more ribs protruding from the exterior surface around all or a portion of the circumference of the exterior surface.

88. The apparatus of claim 77, wherein the exterior surface of the tubular member comprises:
a lower portion including one or more longitudinal ribs protruding from the exterior surface.

89. The apparatus of claim 77, wherein the outlet member includes a substantially cylindrical exterior region and a tapered end.

90. The apparatus of claim 77, wherein the outlet region further comprises:
a guard member attached to the lower surface of the outlet plate, the guard member including an interior region, where the outlet member is positioned within the interior region of the guard member.
